(19) United States
(12) Patent Application Publication
(10) Pub. No.: US 2011/0185879 A1
(43) Pub. Date: Aug. 4, 2011

(54) Manually Operated Educational Device and Method for Conveying Relative Music Theory Concepts for Multiple Instruments

(76) Inventor: Clinton Clay Cole, Columbus, OH (US)

(21) Appl. No.: 12/843,880

(22) Filed: Jul. 27, 2010

Related U.S. Application Data
(60) Provisional application No. 61/228,960, filed on Jul. 27, 2009.

(51) Int. Cl. G09B 15/00

(52) U.S. Cl. 84/470 R

(57) ABSTRACT

An educational device permitting the conveyance of multiple relative topical concepts and method for applying music theory to multiple instruments. The described embodiments have a front layer and back layer, with a plurality of windows permitting visibility of two rotationally mounted inner discs having central pivotal attachments that secure all physical elements. The first and second embodiments illustrate music theory concepts pertaining to chords on the front layer, and music theory concepts pertaining to scales on the back layer. Information imprinted on each side of the inner discs is organized in the musical cycle of fifths to align with the windows on the outside layers and is relative imprinted information of the outside layers. The inner discs are synchronized for the consistent display of selective information, permitting a user to determine the physical application of chords and scales in any key and harmonic relationships. Other embodiments are described and shown.

### CROSS-REFERENCE TO RELATED APPLICATIONS

This application claims the benefit of provisional patent application App. No. 61/228,960, filed 2009 Jul. 27 by the present inventor.

### BACKGROUND

1. Field

The invention relates to the class of tools used for the educational conveyance of information.

2. Prior Art

The following is a tabulation of some prior art that presently appears relevant:

U.S. Patents

| Pat. No. | Kind Code | Issue Date | Patentee |
|---|---|---|---|
| 3,129,628 | — | 1964-04 | Hall |
| 4,503,748 | — | 1985-03-12 | Barber, Jr. |
| 2,649,008 | — | 1953-08 | Bova et al. |
| 7,141,731 | B2 | 2006-11-28 | Vallery |
| 4,305,323 | — | 1981-12-15 | Graham |
| 3,969,973 | — | 1976-07-20 | Pandapas, Jr. |

Traditionally the most common method to learn concepts in any educational filed is to search for information using printed materials such as books, magazines, newspapers an more recently the internet. Music theory is most commonly taught in a classroom or self-taught in the home by using bulky, expensive chord books or multiple other devices. Gathering information in any of the mentioned mediums is time consuming, unorganized, and it doesn't make the educational process any easier or enjoyable.

Several types of educational devices illustrating the concepts of music theory that utilize a single or multiple discs in a rotational fashion and having stacked layers, with a mechanism for viewing selective information have been proposed.

U.S. Pat. No. 4,503,748 to Barber, Jr. (1985), U.S. Pat. No. 2,649,008 to Bova et al. (1953) have the ability to convey music theory concepts pertaining to chords and include visual illustrations for the placement of a users fingers for chords in relation to the instrument, but fail to visually illustrate scale concepts, make use of all available device real-estate, be compatible with multiple instrument types, convey the harmonic relationship between chords and scales or include a simple method to understand and apply the concepts of the device.

U.S. Pat. No. 7,141,731 to Vallery (2006), U.S. Pat. No. 4,305,323 to Graham (1981), and U.S. Pat. No. 3,969,973 to Pandapas, Jr. (1976) have the ability to convey music theory concepts pertaining to both chords and scales, but fail to visually illustrate chord scale concepts, make use, in operation, all available device real-estate, or include a simple method to understand and apply the concepts of the device.

U.S. Pat. No. 3,129,628 to Hall (1964) has the ability to visually illustrate music theory concepts and makes use of all available real-estate on the device, but fails to visually illustrate the application of chords and scales in relation to an instrument, is limited to the explanation of a single instrument type, doesn't include a simple method to understand and apply the concepts of the device and is intended for the instruction of reading musical notation.

Music theory devices illustrating musical notation or lettered notes to illustrate their information without visual aids limit the use of the device to users who have prior knowledge of music theory, this ultimately narrows the market potential for the product. For a consumer to properly use these types of devices they must learn the concepts of musical notation and the meaning of each letter in the musical scales. Music theory devices such as these don't accommodate visual learners or consumers who don't want to learn the intricacies of music theory but just want to play an instrument. Music theory devices designed for a single instrument limit the market potential of that product and leave out consumers who happen to play other instruments.

### SUMMARY

In accordance to one embodiment an educational device conveys interchangeable relative concepts in a manner that visually illustrates the application of the conveyed concepts. The relative concepts are conveyed in a selective manner displayed through windows on a front outside layer and back outside layer and interchangeable by rotation of synchronized inner discs.

### ADVANTAGES

Accordingly several advantages of one or more aspects are as follows: to provide an education device that conveys complete relative musical concepts, that permits a user to acquire the necessary knowledge required to apply themselves on a musical instrument, that can be easily used and understood by all skill levels, that can be inexpensively manufactured, and that is portable. Other advantages will be apparent from a consideration of the drawings and ensuing descriptions.

### DRAWINGS

### Figures

In the drawings closely related figures have the same number but different alphabetic suffixes.

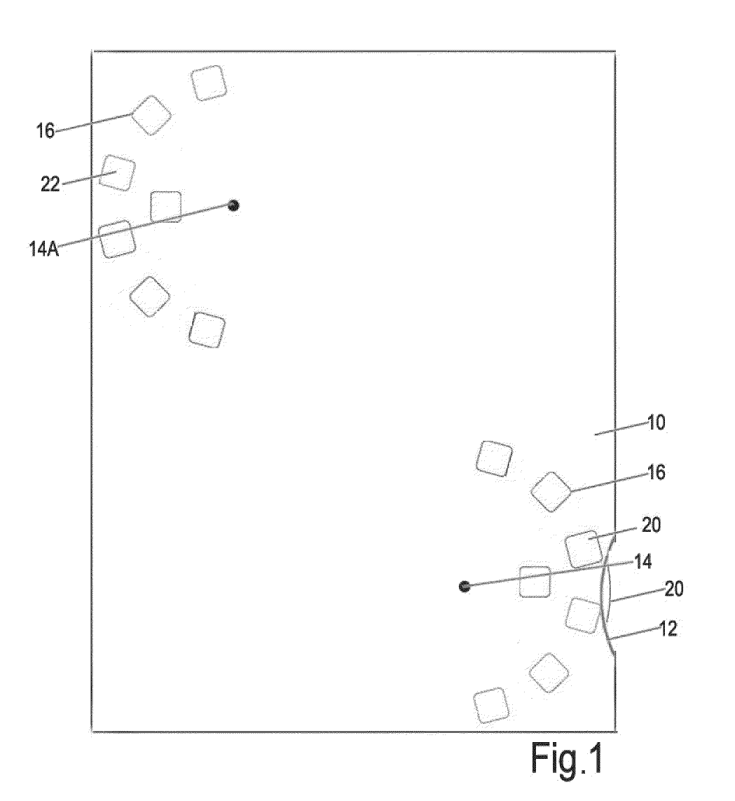

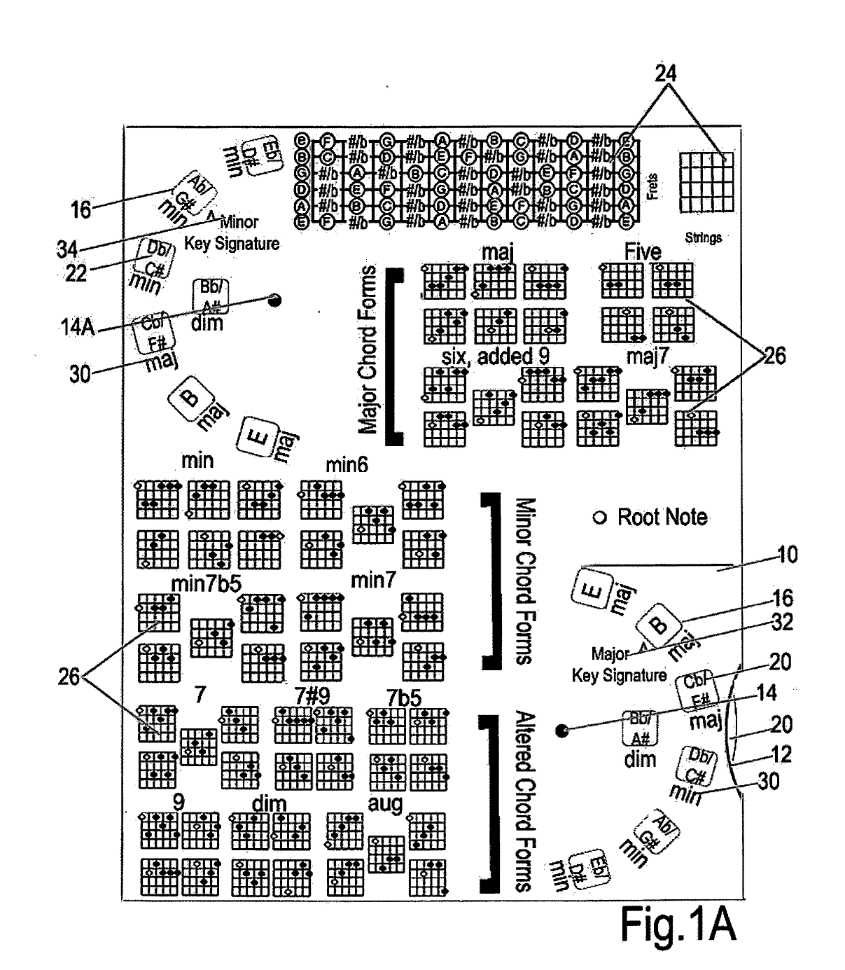

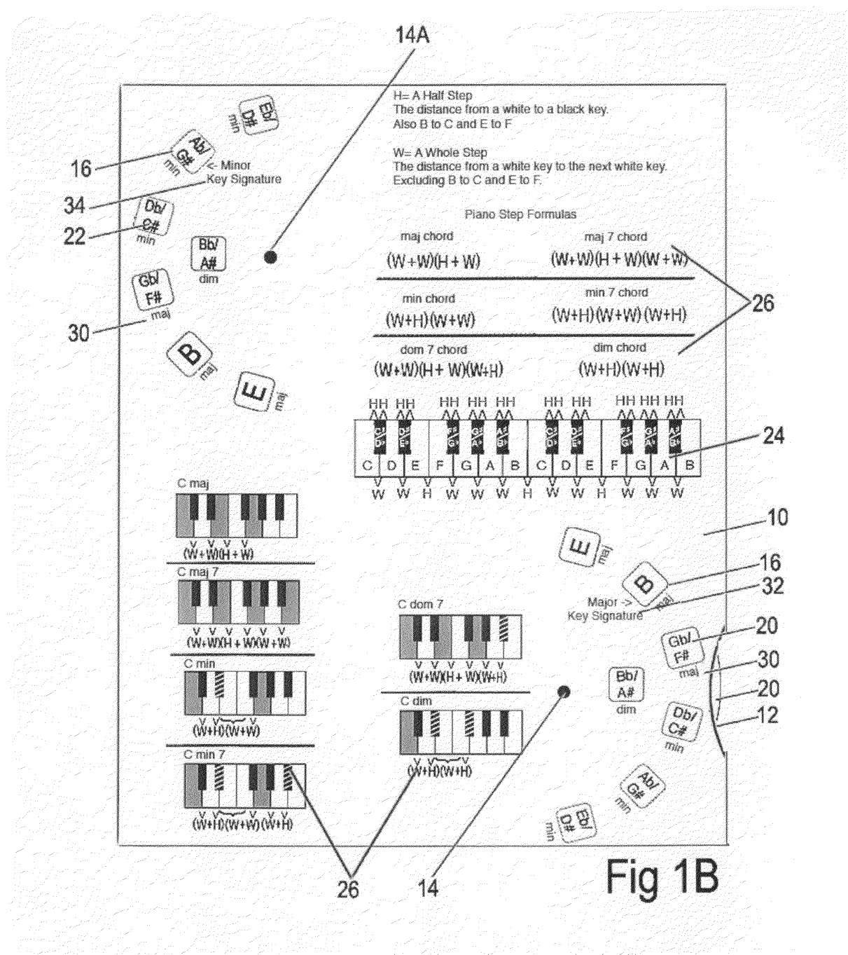

FIG. 1 is an overall view of the physical elements that comprise a first outside layer of the device, with areas of the inner discs visible through the windows in accordance with all possible embodiments.

FIG. 1A is an overall view of the physical and imprinted elements that comprise the first outside layer of the device for a stringed instrument, with letters imprinted on side one of the inner discs visible through the windows in accordance with the first embodiment

FIG. 1B is an overall view of the physical and imprinted elements that comprise the first outside layer of the device for a stringed instrument, with letters imprinted on side one of the inner discs visible through the windows in accordance with the second embodiment.

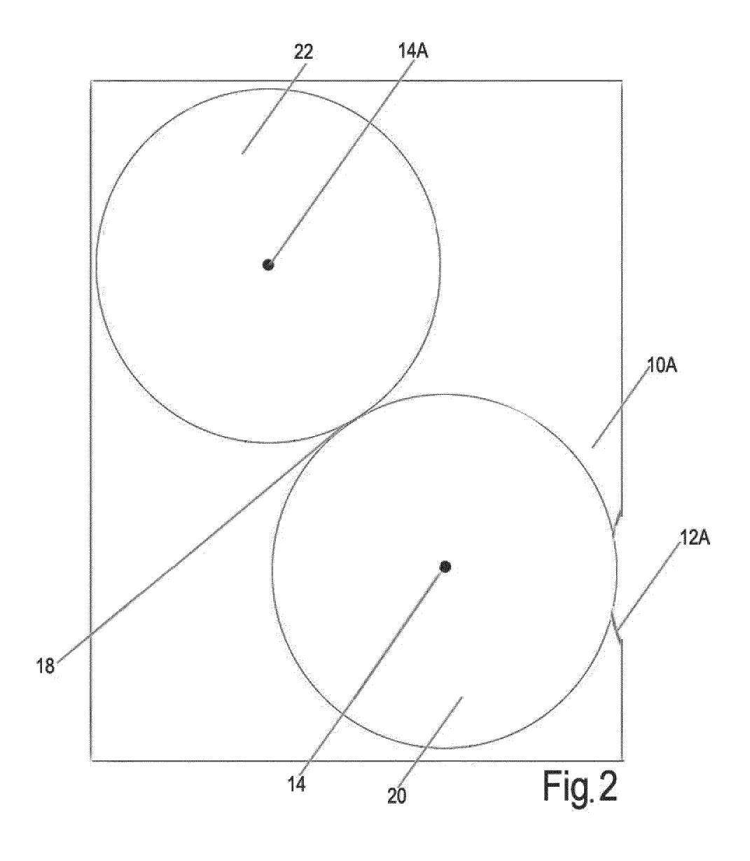

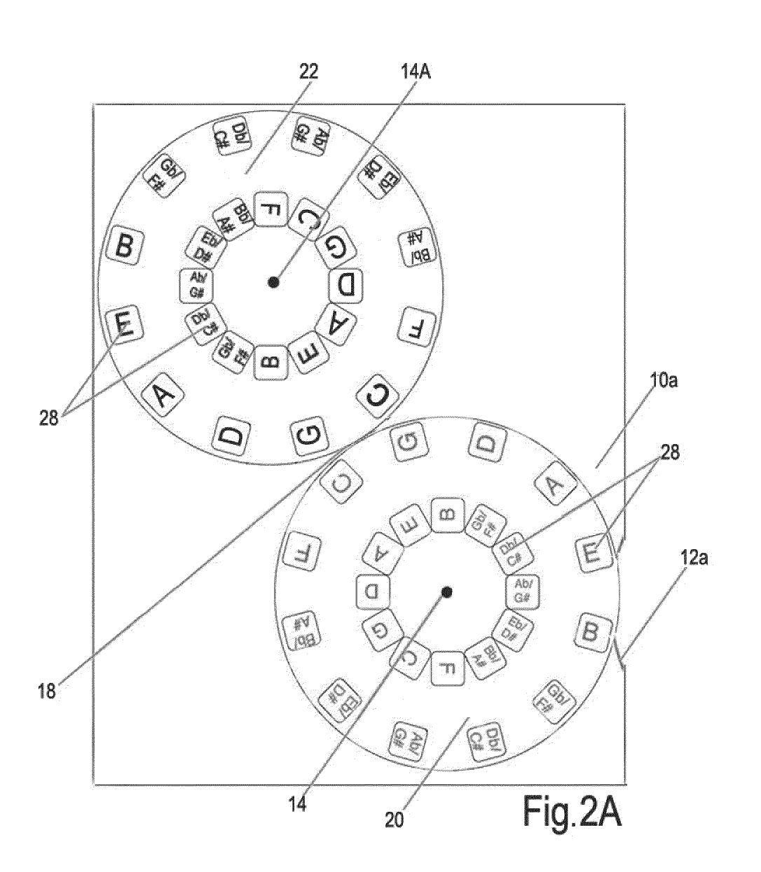

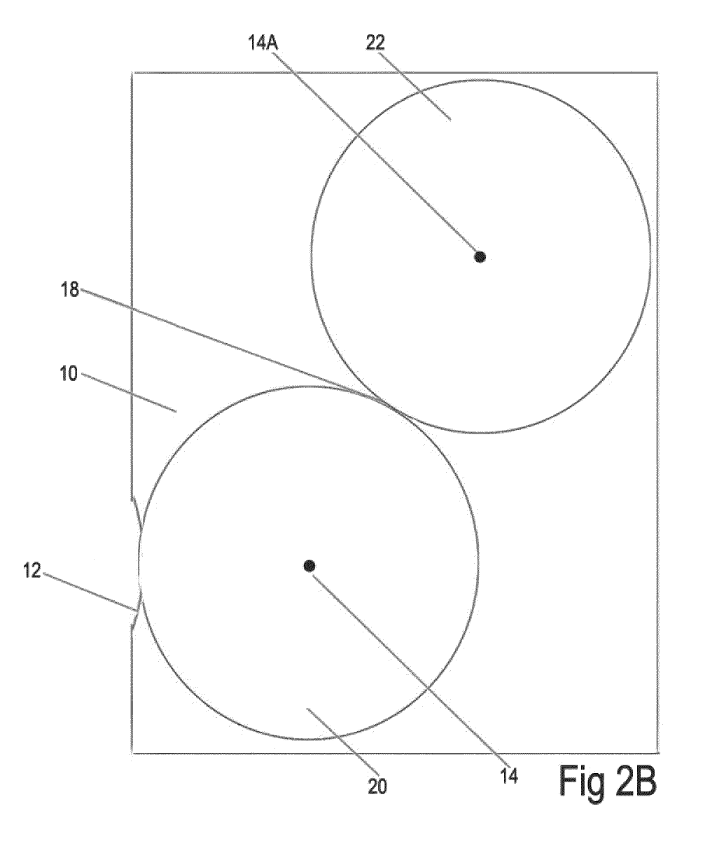

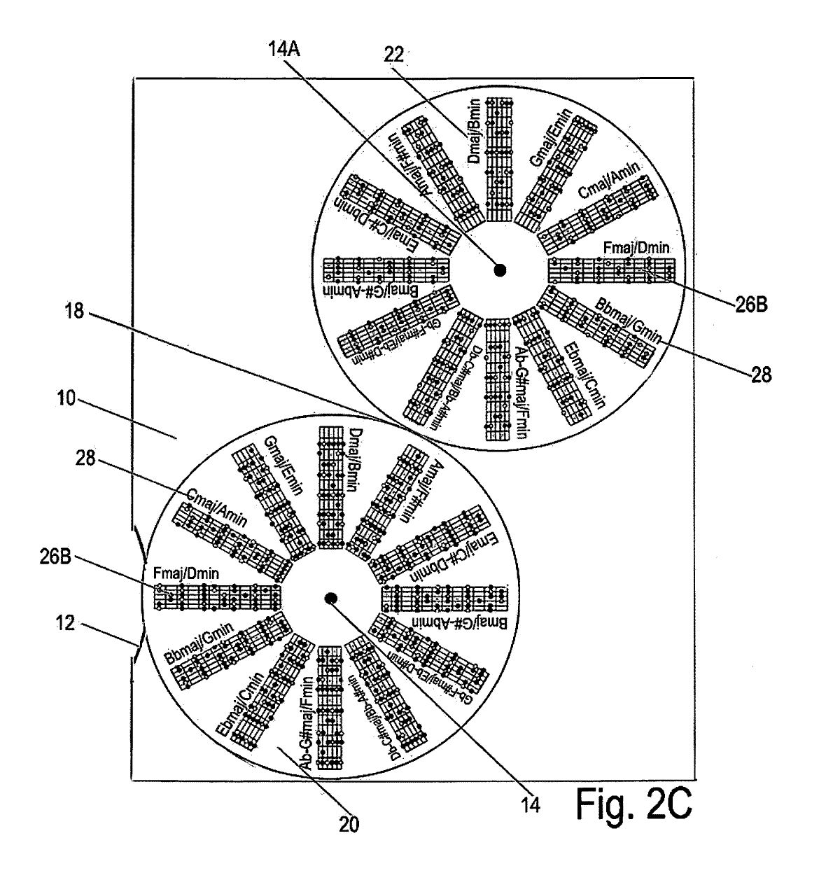

FIG. 2 is an overall view of the physical elements that comprise side one of the inner discs, with the second outside layer visible behind the inner discs in accordance with all possible embodiments.

FIG. 2A is an overall view of the physical and imprinted elements that comprise side one of the inner discs, with the second outside layer visible behind the inner discs in accordance with the first and the second embodiment.

FIG. 2B is an overall view of the physical elements that comprise side two of the inner discs, with the first outside layer visible behind the inner discs in accordance with all possible embodiments.

FIG. 2C is an overall view of the physical and imprinted elements that comprise side two of the inner discs for stringed instruments, with the first outside layer visible behind the inner discs in accordance with first embodiment.

FIG. 2D is an overall view of the physical and imprinted elements that comprise side two of the inner discs for keyboard instruments, with the first outside layer visible behind the inner discs in accordance with the second embodiment.

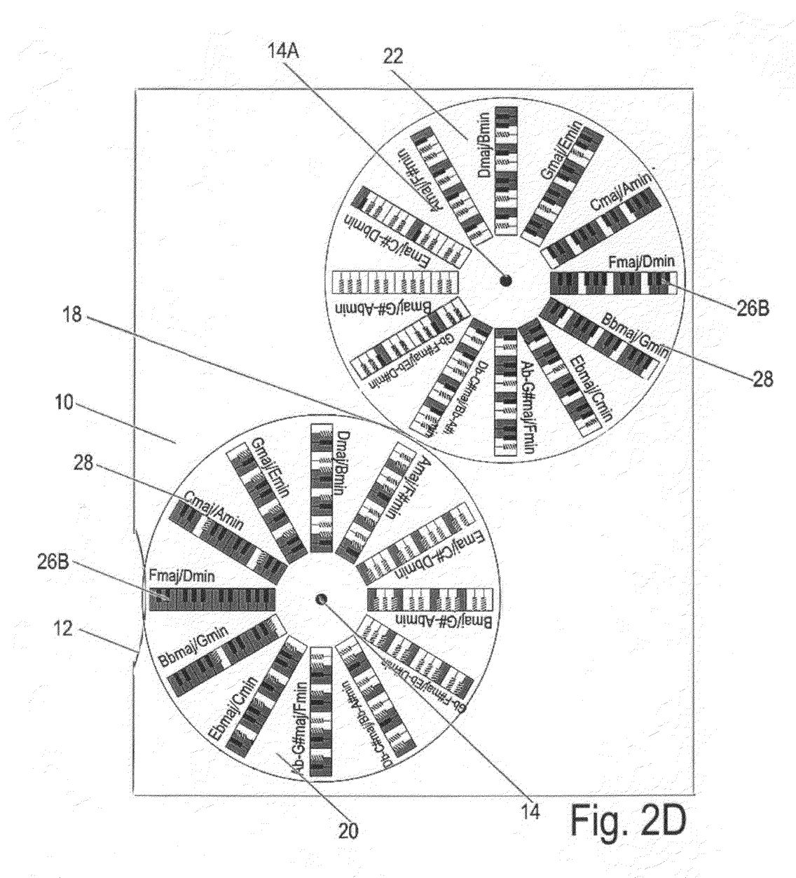

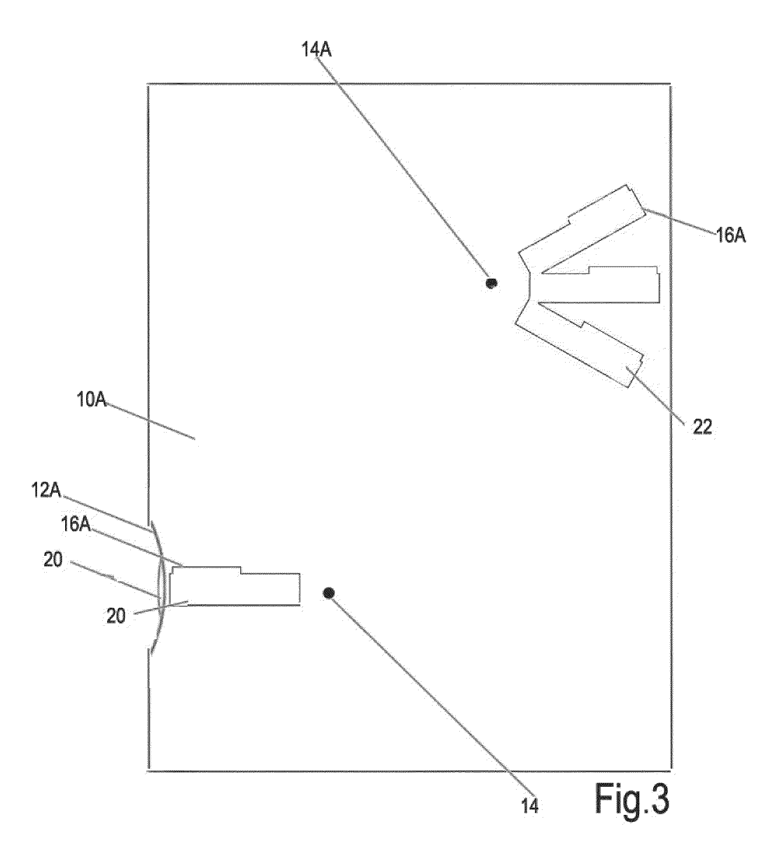

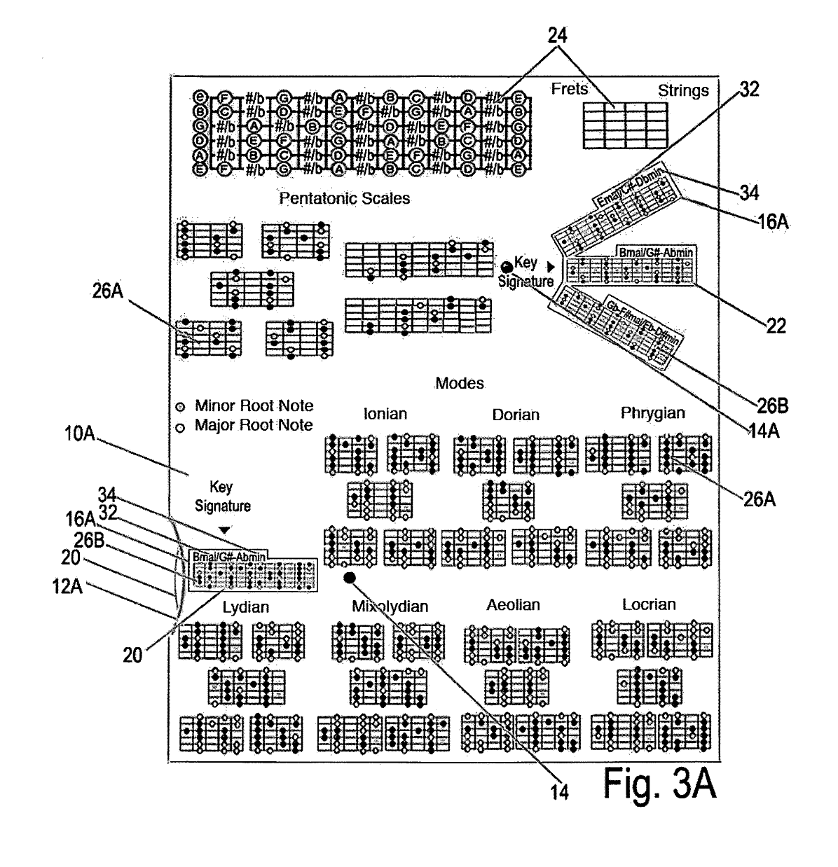

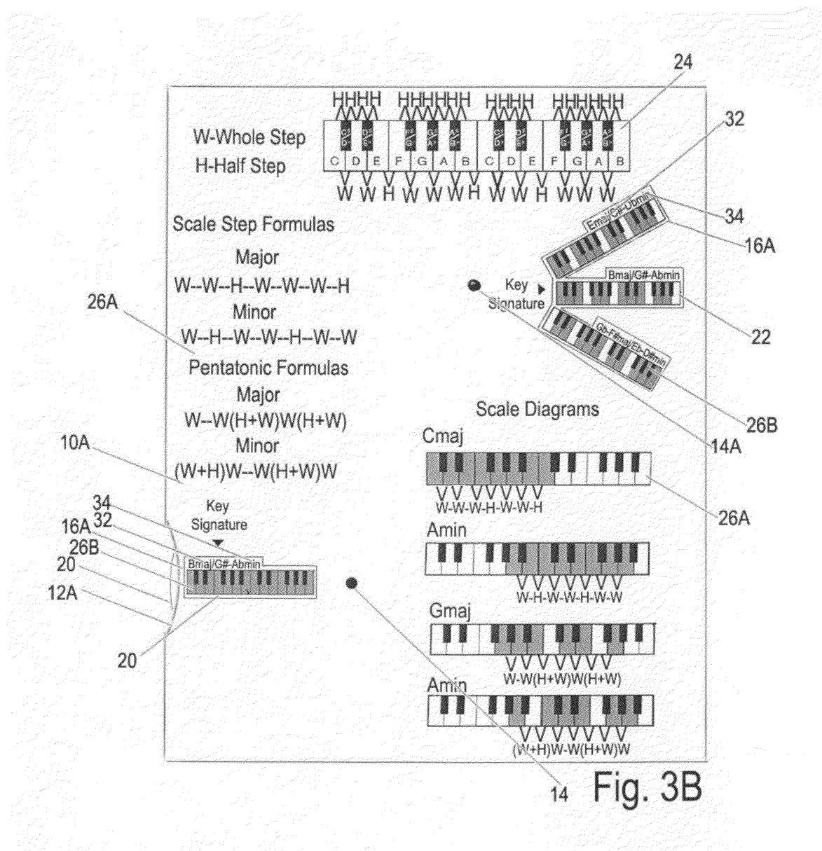

FIG. 3 is an overall view of the physical elements that comprise a second outside layer of the device, with areas of the inner discs visible through the windows in accordance with all possible embodiments.

FIG. 3A is an overall view of the physical and imprinted elements that comprise a second outside layer of the device for a stringed instrument, with imprinted instrument key diagrams on the inner discs visible through the windows in accordance with the first embodiment.

FIG. 3B is an overall view of the physical and imprinted elements that comprise a second outside layer of the device for a keyboard instrument, with imprinted instrument key diagrams on the inner discs visible through the windows in accordance with in accordance with the second embodiment.

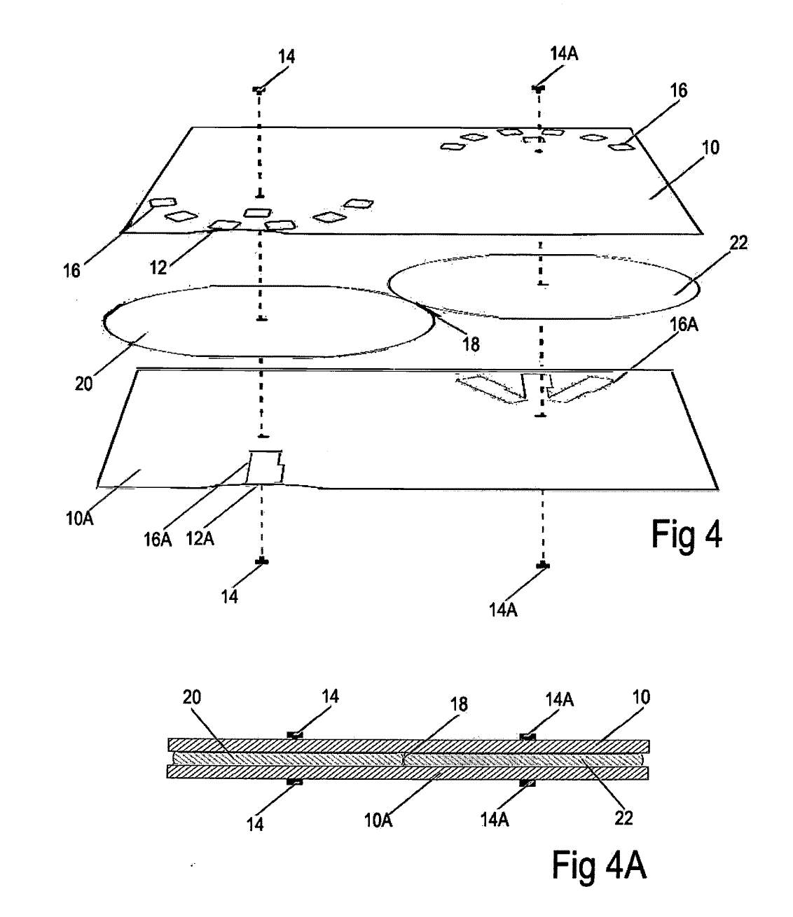

FIG. 4 is a break away view of the order of construction of the device in accordance with all possible embodiments.

FIG. 4A is a side horizontal view of the order of construction of the device in accordance with all possible embodiments.

### REFERENCE NUMERALS

10—Front Layer
10a—Back Layer
12—First Indented Section
12a—Second Indented Section
14—First Pivotal Attachment
14a—Second Pivotal Attachment
16—Front Layer Windows
16a—Back Layer Windows
18—Link Point
20—First Inner Disc
22—Second Inner Disc
24—Instrument Reference Guides
26—Chord Diagrams
26a—Scale Diagrams
26b—Instrument Key Diagrams
28—Cycle Of Fifths
30—Chord Tonalities
32—Major Key
34—Minor Key

### DETAILED DESCRIPTION

### FIG. 1A, 2A, 2C, FIG. 3A

### First Embodiment

FIG. 1A shows front layer 10 with two inner discs 20, 22 rotationally mounted on the inside of front layer 10. Front layer 10 illustrated in FIG. 1A can be made of any sufficient predetermined material, such as plastic, cardboard, wood, poster board, or metal, etc. Front layer 10 illustrated in FIG. 1A has a first indented section 12 exposing the edge of first inner disc 20. A plurality of front layer windows 16 exposing a plurality of letters on the front side of inner discs 20, 22 are shown in FIG. 1A. Front layer 10 illustrated in FIG. 1A has two pivotal attachments 14, 14A attaching front layer 10 to inner discs 20, 22 and a back layer 10A (see FIG. 3A). Front layer 10 illustrated in FIG. 1A is shown with imprinted music theory information pertaining to chords for stringed instruments. The imprinted information on front layer 10 of FIG. 1A includes, instrument reference guides 24, chord diagrams 26, chord tonalities 30, major key signature 32 and relative minor key signature 34.

FIG. 2A shows the front side of inner discs 20, 22 rotationally mounted on the inside of a back layer 10A (see FIG. 3A). Inner discs 20, 22 illustrated in FIG. 2A can be made of any sufficient predetermined material, such as plastic, cardboard, wood, poster board, or metal, etc. FIG. 2A shows the front side of inner discs 20, 22 having two pivotal attachments 14, 14A centrally positioned and attached to back layer 10A. A link point 18 is shown in FIG. 2A interlocking the perimeter of inner discs 20, 22. Link point 18 functions as a gear type mechanism but is not limited to a gear. Any mechanism that would allow the simultaneous rotation of inner discs 20, 22 when inner disc 20 is manually rotated would suffice. FIG. 2A shows a second indented section 12A on back layer 10A. Shown in FIG. 2A are a multitude of imprinted letters organized sequentially in the musical cycle of fifths 28 and organized in circles on the front side of discs 20, 22. The letters illustrated in FIG. 2A are organized in conjunction with the front layer windows 16 (see FIG. 1A).

FIG. 2C shows the back side of inner discs 20, 22 rotationally mounted on the inside of front layer 10. Inner discs 20, 22 illustrated in FIG. 2C are shown having two pivotal attachments 14, 14A centrally positioned and attached to front layer 10. Link point 18 is shown in FIG. 2C interlocking the perimeter of inner discs 20, 22. FIG. 2C shows first indented section 12 on front layer 10. Inner discs 20, 22 illustrated in FIG. 2C show a multitude of instrument key diagrams 26B on the back side of inner discs 20, 22. Instrument key diagrams 26B illustrated in FIG. 2C are shown organized around the musical cycle of fifths 28 and are in conjunction with back layer windows 16A illustrated on back layer 10A (see FIG. 3A).

FIG. 3A shows back layer 10A with the back side of inner discs 20, 22 rotationally mounted on the inside of back layer 10A. Back layer 10A illustrated in FIG. 3A can be made of any sufficient predetermined material, such as plastic, cardboard, wood, poster board, or metal, etc. Back layer 10A illustrated in FIG. 3A has a second indented section 12A shown exposing the perimeter of inner disc one 20. A multitude of back layer windows 16A exposing a multitude of areas on the back side of inner discs 20, 22 are shown in FIG. 3A. FIG. 3A illustrates two pivotal attachments 14, 14A shown connecting back layer 10A to the back of inner discs 20, 22. Back layer 10A of FIG. 3A is shown with the imprinted music theory information pertaining to scales for stringed instruments. The imprinted information on back layer 10A of FIG. 3A includes instrument reference guides 24, scale diagrams 26A, major key signature 32 and relative minor key signature 34.

### Operation—FIGS. 1A, 2A, 2C, and FIG. 3A

The manner of using the device and its method is unique to itself. First indented section 12 on front layer 10 (see FIG. 1A) aligned with second indented section 12A on back layer 10A (see FIG. 3A) exposes the edge of inner disc 20. The exposed edge of inner disc 20 (see FIGS. 1A, 3A) allows for manual rotation of inner disc 20 around pivotal attachment 14. Rotating inner disc 20 simultaneously rotates inner disc 22 around pivotal attachment 14A keeping the information visible through the front and back layer windows 16, 16A synchronized on both sides of each inner disc 20, 22. Rotating inner disc 20 clockwise or counterclockwise allows the user to change the selected information visible through front and back layer windows 16, 16A. Both sides of the device function in the same manner while conveying different relative concepts.

Front layer 10 illustrated in FIG. 1A shows imprinted information conveying music theory concepts specifically for chords. The imprinted chord information and front layer windows 16 on front layer 10 shown in FIG. 1A are relative to the imprinted letters on inner discs 20, 22. The letters are organized in circles and each letter is sequentially ordered a fifth apart within the musical alphabet. Ordering letters into intervals of fifths sequentially lists seven notes of any major key 32 and relative minor key 34, depending on the selected seven letters in the sequence. For example the musical alphabet consists of the letters A, B, C, D, E, F, G. In reference to the musical alphabet the letter F and C are an interval of five letters apart, starting on F(1), G(2), A (3), B(4), C(5). When intervals of fifths are counted from the letter F for seven letters, F, C, G, D, A, E, and B, the notes in the key signature of C major and its relative minor key signature A minor are listed. These notes make up the C major and A minor scale, as well as the chords of each key signature. This specific intervallic sequence of letters is organized in circles on the front side of inner discs 20, 22 in FIG. 2A. Front layer windows 16 on front layer 10 illustrated in FIG. 1A allow for visibility of fourteen letters imprinted on the inner discs 20, 22, seven front layer windows for each key signature shown. Each set of seven front layer windows 16 displays a major key 32 and its relative minor key 34 simultaneously. Each front window 16 is labeled with the chord tonality 30 and each visible letter from inner discs 20, 22 represent a chord in the selected key signature.

Along with interchangeable key signatures that illustrate each chord on inner discs 20, 22, imprinted chord information included on front layer 10 in FIG. 1A. Chord diagrams 26 and instrument reference diagrams 24 imprinted on front layer 10 in FIG. 1A are used to determine the placement of a users fingers on the instrument and to locate the desired chord using its letter name, allowing a user to visually determine how to play a chord and its location in relation to the instrument.

Back layer 10A illustrated in FIG. 3A shows music theory concepts specifically for scales. The imprinted scale information and back layer windows 16A on back layer 10A illustrated in FIG. 3A are in conjunction and relative to the imprinted instrument key diagrams 26B that are sequentially ordered in the musical cycle of fifths 28 and organized in circles on the inner discs 20, 22. The same organizational concept of fifth intervals utilized on the front side of inner discs 20, 22 in FIG. 2A is utilized on the back side of inner discs 20, 22 FIG. 2C. The back side of inner discs 20, 22 each have twelve instrument key diagrams 26B. Instrument key diagrams 26B imprinted on inner disc 20 convey every possible location of all seven notes of any major key 32 and its relative minor key 34 in relation to an instrument. Instrument key diagrams 26B imprinted on inner disc 22 convey every possible location of the five note pentatonic scale of any major key 32 and its relative minor key 34 in relation to an instrument. Instrument key diagrams 26B imprinted on the back side of inner discs 20, 22 are synchronized so that the same key signatures are visible through back layer windows 16A. When a key signature is selected on the back layer 10A in FIG. 3A the diatonic scale, pentatonic scale and all seven modes are displayed. Scale diagrams 26A and instrument reference guides 24 imprinted on back layer 10A in FIG. 3A are used to determine the placement of a users fingers and location of a scale using its letter name. This allows a user to visually determine how to play a scale and its location in relation to the instrument.

Synchronizing information isn't limited to one side of the device. Letters imprinted on the front side of inner discs 20, 22 are synchronized with the instrument key diagrams 26B imprinted on the back side of inner discs 20, 22. Synchronizing all of the imprinted information visible on each side of inner discs 20, 22 permits the device to convey any major key 32 and its relative minor key 34, chords, and scales within the selected key signature; while illustrating the harmonic relationship of the chords and scales in any selected key signature.

The utility and method of the one embodiment allows for fast reference to any chord or scale information necessary for the physical application to an instrument.

### FIGS. 1B, 2D, and FIG. 3B

### Second Embodiment

One additional embodiment of the device is illustrated in FIG. 1B, 2D, FIG. 3B. This additional embodiment is comprised of the same elements and constructed in the exact same way as the first embodiment of the device. This additional embodiment includes all of the same imprinted information in concept as the previously described embodiment but illustrated for keyboard instruments. Front outside layer 10 of FIG. 1B is shown with imprinted information for keyboard instruments. The imprinted information for keyboard instruments on front outside layer 10 of FIG. 1B includes instrument reference guides 24, chord diagrams 26, chord tonalities 30, major key signature 32 and relative minor key signature 34.

FIG. 2D shows instrument key diagrams 26B for a keyboard instrument on the back side of inner discs 20, 22 sequentially ordered in the musical cycle of fifths 28 and organized in circles.

Back layer 10A of FIG. 3B is shown with imprinted information for keyboard instruments. The imprinted information for keyboard instruments on back layer 10A of FIG. 3B includes instrument reference guides 24, scale diagrams 26A, major key signature 32 and its relative minor key signature 34.

### FIGS. 1B, 2D, and FIG. 3B—Operation

The operation of this second embodiment is the exact same as the operation of the first embodiment, except the conveyed music theory information is illustrated for a keyboard instrument.

### FIGS. 1, 2, 2B, and FIG. 3

### Alternate Embodiments

One alternative embodiment of the device is illustrated in FIG. 1, FIG. 2, FIG. 2B, and FIG. 3. This alternative embodiment is illustrated without any imprinted educational information. The blank illustrations are intended to convey the devices usefulness in other educational fields such as, math, language, or science and not limiting its utility to music theory.

FIG. 1 shows front layer 10 being of any sufficient predetermined material, such as plastic, cardboard, wood, poster board, or metal, etc. Front layer 10 has a first indented section 12 exposing the edge of a inner disc one 20. A plurality of front layer windows 16 are shown exposing a plurality of areas on the front side of inner discs 20, 22. FIG. 1 illustrates two pivotal attachments 14, 14A shown attaching front layer 10 to inner discs 20, 22.

FIG. 2 shows the front side of inner discs 20, 22 mounted on the inside of back layer 10A. Any sufficient predetermined material can be used for inner discs 20, 22, such as plastic, cardboard, wood, poster board, or metal, etc. FIG. 2 shows the front side of inner discs 20, 22 having two pivotal attachments 14, 14A centrally positioned and attached to back layer 10A. A link point 18 is shown in FIG. 2 interconnecting the perimeter of inner discs 20, 22. Link point 18 is a gear type mechanism but is not limited to a gear. FIG. 2 also shows a second indented section 12A on back layer 10A behind inner discs 20, 22.

FIG. 2B shows the back side of inner discs 20, 22 having two pivotal attachments 14, 14A centrally positioned and mounted to the inside of front layer 10. Link point 18 is shown in FIG. 2B interconnecting the perimeter of inner discs 20, 22. FIG. 2B shows a first indented section 12 on front layer 10.

FIG. 3 shows back layer 10A being of any sufficient predetermined material, such as plastic, cardboard, wood, poster board, or metal, etc. Back layer 10A has a second indented section 12A shown exposing the edge of first inner disc 20. FIG. 3 shows a plurality of back layer windows 16A exposing a plurality of areas on the back side of inner discs 20, 22. FIG. 3 illustrates two pivotal attachments 14, 14A shown attaching back layer 10A to the back side of inner discs 20, 22.

### FIGS. 1, 2, 2B, and FIG. 3—Operation

The manner of using the device alternate embodiments and its method is unique to itself. First indented section 12 on front layer 10 (see FIG. 1) aligned with second indented section 12A on back layer 10A (see FIG. 3) exposes the edge of inner disc 20. The exposed edge of inner disc 20 (see FIGS. 1, 3) allows for manual rotation of inner disc 20 around pivotal attachment 14. Rotating inner disc 20 simultaneously rotates inner disc 22 around pivotal attachment 14A keeping the information displayed through the front and back windows 16, 16A synchronized on both sides of each inner disc 20, 22. Rotating inner disc 20 clockwise or counterclockwise allows the user to change the selected information visible through front and back layer windows 16, 16A. Both sides of the device function in the same manner while conveying different relative concepts.

### FIG. 4 and FIG. 4A—Construction

FIG. 4 is exploded perspective showing the order of construction of the device. Front layer 10 is shown on top with front layer windows 16 visible. Two pivotal attachments 14, 14A securing all of the components of the device to each other are shown. FIG. 4 shows the front side of inner discs 20, 22 facing up. Link point 18 is shown interconnecting inner discs 20, 22 at their perimeter. The inside of back layer 10A and back layer windows 16A are shown. First indented section 12 and second indented section 12A are shown in the preferred locations but not limited to this location.

FIG. 4A is a horizontal side view of the construction of the device. Front layer 10 is shown on top of inner discs 20, 22. Back layer 10A is show under inner discs 20, 22. Pivotal attachments 14, 14A are shown securing all elements of the device to each other. In FIG. 4 A link point 18 is shown interconnecting inner discs 20, 22 at their perimeter.

### Advantages

From the description above, a number of advantages of some embodiments of my educational device become evident:
(a) The imprinted information, diagrams, the method and organization thereof can convey separate individual concepts, as well as convey the relationship between separate concepts.
(b) The imprinted information, diagrams, the method and organization thereof supplements a variety of learners.
(c) The imprinted information, diagrams, the method and organization thereof permits instant use because the diagrams have no underlying or implied meaning. They tell the user the exact location of the included information and limits of each illustrated musical concept.
(d) The first and second embodiment replaces the need for bulky chord and scale books by condensing them into a single source.
(e) Alternate embodiments reducing the amount of sources traditionally required to retrieve information to a single device.
(f) The first and second embodiments are compatible with a multitude of instruments, maximizing market potential and assisting to the needs of a wide range of musicians.

### CONCLUSION, RAMIFICATIONS, AND SCOPE

Accordingly, the reader will see a multitude of topical concepts of the various embodiments can be used to acquire and apply any included concepts. The various embodiments and any additional embodiment minimize the amount of research a user would have to do for any compatible topical concept by organizing information on a single device. Furthermore, the educational device has additional advantages in that:
it permits a user to transpose one key signature to another;
it allows a user to compose their own songs by illustration the harmonic function and structure of music.
it allows a user to learn songs by ear through reference to the educational device once the key of the desired tune is known

Although the description above contains many specificities, these should not be construed as limiting the scope of the embodiments but as merely providing illustrations of some of several embodiments. For example: the educational device can include information conveying topical concepts other than music, such as mathematical, language, scientific or any other theoretical topic with consistent concepts.

Thus the scope of the embodiments should be determined by the appended claims and their legal equivalents, rather than by the examples given.

I claim:

1. A manually operated educational device comprising a front layer having a predetermined size with a plurality of predetermined front layer windows permitting visibility through said front layer, a first inner disc contiguously interconnected to a second inner disc having a predetermined circumference and sandwiched between said front layer, and a back layer having a predetermined size with a plurality of predetermined back layer windows permitting visibility through said back layer, said inner discs are attached to said front layer and said back layer with a first pivotal attachment and a second pivotal attachment, whereby permitting the simultaneous clockwise and counterclockwise rotation of said inner discs by means of manually rotating said first inner disc in conjunction with a link point interconnecting the edge of said inner discs.

2. The educational device of claim 5, wherein said front and back layers have a uniform rectangular shape.

3. The educational device of claim 5, wherein said inner discs have a uniform circumference.

4. The educational device of claim 5, wherein said link point is a gear.

5. The educational device of claim 5, wherein said pivotal attachments are rivets.

6. A manually operated educational device visually illustrating the relationship of a plurality of topical concepts for multiple applications comprising a front layer having a predetermined size, a multitude of imprinted instructional information pertaining to a topical concept and a plurality of predetermined front layer windows permitting visibility through said front layer a first inner disc contiguously interconnected to a second inner disc each having a predetermined circumference, a multitude of imprinted information pertaining to a topical concept and sandwiched between said front layer, and a back layer having a predetermined size, a multitude of imprinted instructional information pertaining to a topical concept and a plurality of predetermined back layer windows permitting visibility through said back layer, said inner discs are attached to said front layer and said back layer by means of a first pivotal attachment and a second pivotal attachment, whereby permitting the simultaneous clockwise or counterclockwise rotation of said first inner disc and said second inner disc by means of manually rotating said first inner disc in conjunction with a link point interconnecting the edge of said first inner disc and the edge of said second inner disc.

7. The educational device of claim 6, wherein said front and back layers have a multitude of imprinted instructional information pertaining to music theory, the front and back sides of said inner discs have a multitude of imprinted information pertaining to music theory, said front and back windows are disposed so that said imprinted information pertaining to music theory on the front and back of said inner discs is visible, whereby alignment of said imprinted information pertaining to music theory with said front and back windows illustrates complete music theory concepts, said inner discs are synchronized so that the said music theory information displayed through said front windows and said back windows is consistent.

8. The educational device of claim 6, wherein said front layer and back layer have a multitude of imprinted music theory information such as, chord diagrams, scale diagrams and instrument reference diagrams pertaining to chords; the front side of said inner discs have a multitude of imprinted letters sequentially ordered in the musical cycle of fifths and organized in a plurality of circles, the back side of said inner discs have a multitude of imprinted instrument key diagrams sequentially ordered in the musical cycle of fifths and organized in a plurality of circles, said front windows are disposed so that said imprinted letters are visible, whereby alignment of said imprinted letters with said front windows displays the notes and chords of any musical key signature and relative information, said back windows are disposed so that a plurality of imprinted instrument key diagrams are visible, whereby alignment of said instrument key diagrams with said back layer windows displays the notes and scales of any musical key signature, each side being synchronized so that the same major key signature and relative minor key signature is displayed through said front layer windows and said back layer windows.

9. The educational device of claim 7 wherein said imprinted music theory information is illustrated for stringed instruments.

10. The educational device of claim 7 wherein said imprinted music theory information is illustrated for keyboard instruments.

11. The educational device of claim 8 wherein said chord diagrams, said scale diagrams, said instrument reference guides and said instrument key diagrams are illustrated for stringed instruments.

12. The educational device of claim 8 wherein said chord diagrams, said scale diagrams, said instrument reference guides and said instrument key diagrams are illustrated for stringed instruments.

13. A method for utilizing a manually operated educational device for understanding relative topical concepts comprising:
(a) rotating a first inner disc clockwise or counterclockwise while;
(b) referring to a plurality of front layer windows allowing visibility of the front side of said first inner disc and a second inner disc permits the manual selection of a plurality interchangeable topical information imprinted on said inner discs;
(c) referring to instructional topical information imprinted on a front layer in conjunction with said interchangeable topical information visible through said front windows illustrates a complete topical concept;
(d) referring to a plurality of back layer windows permitting visibility of a plurality of interchangeable topical information imprinted on the back side of said inner discs while;
(e) referring to instructional topical information imprinted on a back layer in conjunction with said interchangeable topical information visible through said back windows illustrates an complete topical concept while;
(f) illustrating the relationship to said complete topical concept conveyed on said front layer.

14. The method of claim 13, wherein said topical information pertains to music theory

15. The method of claim 13, wherein said instructional topical information imprinted on said front layer pertains to chord concepts in music theory and said instructional topical information imprinted on said back layer pertains to scale concepts in music theory; said topical information imprinted on the front side of said inner discs pertains to chord concepts in music theory and said topical information imprinted on the back of said discs pertains to scale concepts in music theory.

16. The method of claim 14, further applying to stringed instruments.

17. The method of claim 14, further applying to keyboard instruments.

18. The method of claim 15, further applying to stringed instruments.

19. The method of claim 15, further applying to keyboard instruments.
